(19) United States
(12) Patent Application Publication
(10) Pub. No.: US 2015/0186778 A1
(43) Pub. Date: Jul. 2, 2015

(54) SPATIAL REASONER FOR REASONING TOPOLOGICAL RELATION AND DIRECTIONAL RELATION BETWEEN TWO GEO-ENTITIES, METHOD THEREOF, AND RECORDING MEDIUM

(71) Applicant: Foundation of Soongsil University-lndustry Cooperation, Seoul (KR)

(72) Inventors: Young-Tack PARK, Seoul (KR); In-Cheol KIM, Seongnam-si (KR)

(21) Appl. No.: 14/518,964

(22) Filed: Oct. 20, 2014

(30) Foreign Application Priority Data
Dec. 31, 2013 (KR) 10-2013-0168390

(51) Int. Cl. G06N 5/02

(52) U.S. Cl. CPC G06N 5/027

(57) ABSTRACT

There is provided a spatial reasoner for reasoning a topological relation and a directional relation between two geo-entities. The spatial reasoner includes a plurality of spatial knowledge bases in which spatial relations are defined; a spatial reasoning engine configured to infer new spatial relations through a cross consistency check of the spatial knowledge bases; and a query processing engine configured to answer to a spatial query using the new spatial relations inferred from the spatial reasoning engine. Therefore, it is possible to perform efficient and accurate spatial reasoning.

### CROSS-REFERENCE TO RELATED APPLICATION

This application claims priority to and the benefit of Korean Patent Application No. 2013-0168390, filed on Dec. 31, 2013, the disclosure of which is incorporated herein by reference in its entirety.

### BACKGROUND OF INVENTION

The present invention relates to a spatial reasoner configured to reason a topological relation and a directional relation between two geo-entities, a method thereof, and a recording medium, and more specifically, to a spatial reasoner configured to reason a topological relation and a directional relation between two geo-entities based on RCC-8 and CSD-9 theories, a method thereof, and a recording medium.

Recently, the event in which the IBM Watson system won against human contestants on the quiz show Jeopardy offered a chance to provide a new driving force in almost all fields of artificial intelligence such as natural language processing, query and answer, knowledge representation and reasoning, and evidence-based learning. In order to effectively answer questions given in the quiz show, a comprehensive knowledge base including people, geography, events, history, and the like and a rapid spatio-temporal reasoning ability are necessary.

Demands for efficient qualitative spatial reasoners capable of inferring a topology and a directional relation between different geo-entities are increasing focused on a large scale geographic information system (GIS) in the field of construction, public works, administration, military, and safety management, intelligent learning systems using a large scale spatio-temporal knowledge base of people, geography, and history, intelligent robots and exploration systems, and various other spatio-temporal digital content service fields in addition to such a natural language-based deep query answer (DeepQA) system. In particular, such a qualitative spatial reasoner may be very effectively used when it is difficult to obtain detailed quantitative information such as location coordinates, areas, and shapes of geo-entities or quantitative calculation has high complexity.

In the related art, representative theory research for qualitatively representing and reasoning a topological relation and a directional relation between geo-entities includes region connection calculus (RCC)-8, cone-shaped directional (CSD)-9, and the like. Also, qualitative spatial reasoners developed by international research organizations based on these theories include SOWL, PelletSpatial, CHOROS, and the like.

The SOWL is a spatio-temporal reasoner in which spatio-temporal knowledge is represented as a 4-D fluent and an N-ary relation based on RDF/OWL that is a semantic Web ontology language and reasoning rules are implemented by a semantic Web rule language (SWRL). In this reasoner, Allen's theory was applied for time knowledge representation and reasoning, and CSD-9 and RCC-8 theories were applied for spatial knowledge representation and reasoning respectively. However, the SOWL has a performance that is difficult to be practically used since an implementation method using an SWRL rule engine has a limitation and optimization among spatio-temporal reasoning rules is not sufficiently performed.

Meanwhile, PelletSpatial is an RCC-8 spatial reasoner using a path consistency algorithm having high efficiency, and CHOROS is a spatial reasoner that extends PelletSpatial to support CSD-9 reasoning. However, this reasoner also has a limitation that a reasoning element checking cross consistency between CSD-9 dealing with a directional relation between two spaces and RCC-8 knowledge dealing with an inclusion relation thereof is not included.

### SUMMARY OF THE INVENTION

In view of the above-described problems, the present invention provides a spatial reasoner for accurately and efficiently reasoning a topological relation and a directional relation between two geo-entities.

The present invention also provides a spatial reasoning method of reasoning a topological relation and a directional relation between two geo-entities.

The present invention also provides a recording medium for performing the spatial reasoning method.

According to an aspect of the present invention, there is provided a spatial reasoner for reasoning a topological relation and a directional relation between two geo-entities. The spatial reasoner includes a plurality of spatial knowledge bases in which spatial relations are defined; a spatial reasoning engine configured to infer new spatial relations through a cross consistency check of the spatial knowledge bases; and a query processing engine configured to answer to a spatial query using the new spatial relations inferred from the spatial reasoning engine.

The spatial reasoning engine may include a path consistency checker configured to check path consistency of each of the spatial knowledge bases; and a cross consistency checker configured to check cross consistency between the spatial knowledge bases.

The plurality of spatial knowledge bases may include a knowledge base representing a directional relation between geo-entities; and a knowledge base representing a topological relation between geo-entities.

The plurality of spatial knowledge bases may include a cone-shaped directional (CSD)-9 knowledge base and a region connection calculus (RCC)-8 knowledge base.

The spatial reasoning engine may perform a consistency check using a CSD-9 relation composition table, an RCC-8 composition table, and a CSD-9 and RCC-8 conversion table.

The spatial reasoner may further include a knowledge parser configured to divide and deliver regional knowledge to a spatial knowledge base or a general knowledge base.

The spatial reasoner may further include a query parser configured to, when a spatial query including at least one spatial relation is given, deliver the spatial query to the query processing engine.

The spatial query may use an SPARQL language format.

According to another aspect of the present invention, there is provided a spatial reasoning method of reasoning a topological relation and a directional relation between two geo-entities. The method includes inferring new spatial relations through a cross consistency check of a plurality of spatial knowledge bases in which spatial relations are defined; and answering to a spatial query using the new spatial relations inferred from a spatial reasoning engine.

According to still another aspect of the present invention, there is provided a computer-readable recording medium in which a computer program for performing the above-described method of reasoning a topological relation and a directional relation between two geo-entities is recorded.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a block diagram illustrating a spatial reasoner for reasoning a topological relation and a directional relation between two geo-entities according to an embodiment of the present invention;

FIG. 2 is a conceptual diagram illustrating a method of representing a relation between two geo-entities;

FIG. 3 is a conceptual diagram illustrating CSD-9-based directional relations;

FIG. 4 is a conceptual diagram illustrating RCC-8-based topological relations.

FIG. 5 shows a pseudo code of a CSD/RCC-based spatial reasoning algorithm;

FIG. 6 shows a pseudo code of a path consistency check algorithm of CSD/RCC;

FIG. 7 shows a pseudo code of a cross consistency check algorithm between CSD and RCC;

FIG. 8 shows an execution screen of a spatial reasoner according to the present embodiment;

FIG. 9 is a graph showing quantitative comparison of reasoning knowledge between an algorithm according to the present invention and an algorithm in the related art; and

FIG. 10 is a graph showing certainty comparison of reasoning knowledge between the algorithm according to the present invention and the algorithm in the related art.

### DETAILED DESCRIPTION OF EXEMPLARY EMBODIMENTS

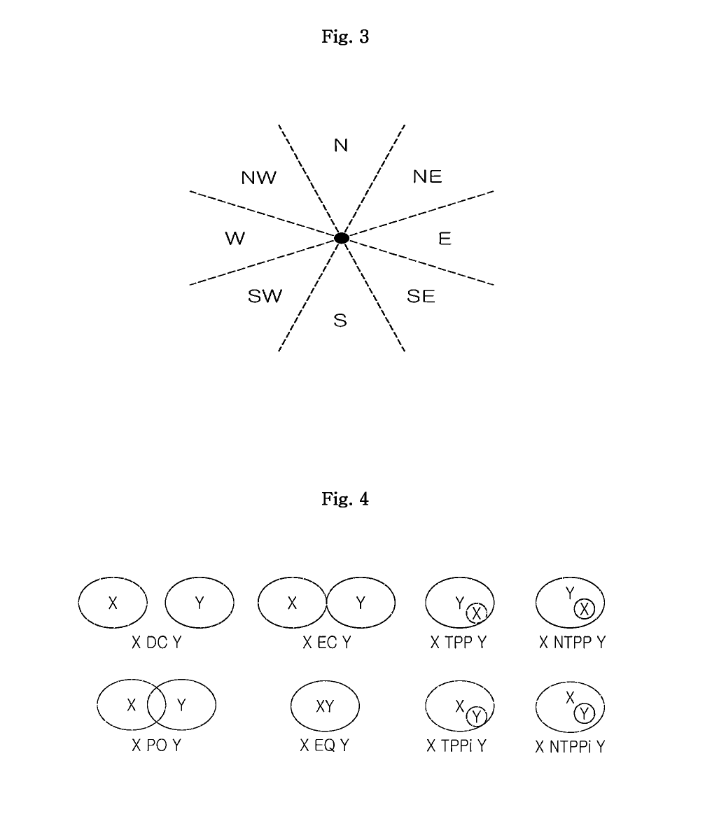

Hereinafter, exemplary embodiments of the present invention will be described in detail with reference to the drawings. FIG. 2 is a conceptual diagram illustrating a method of representing a relation between two geo-entities. FIG. 3 is a conceptual diagram illustrating CSD-9-based directional relations. FIG. 4 is a conceptual diagram illustrating RCC-8-based topological relations.

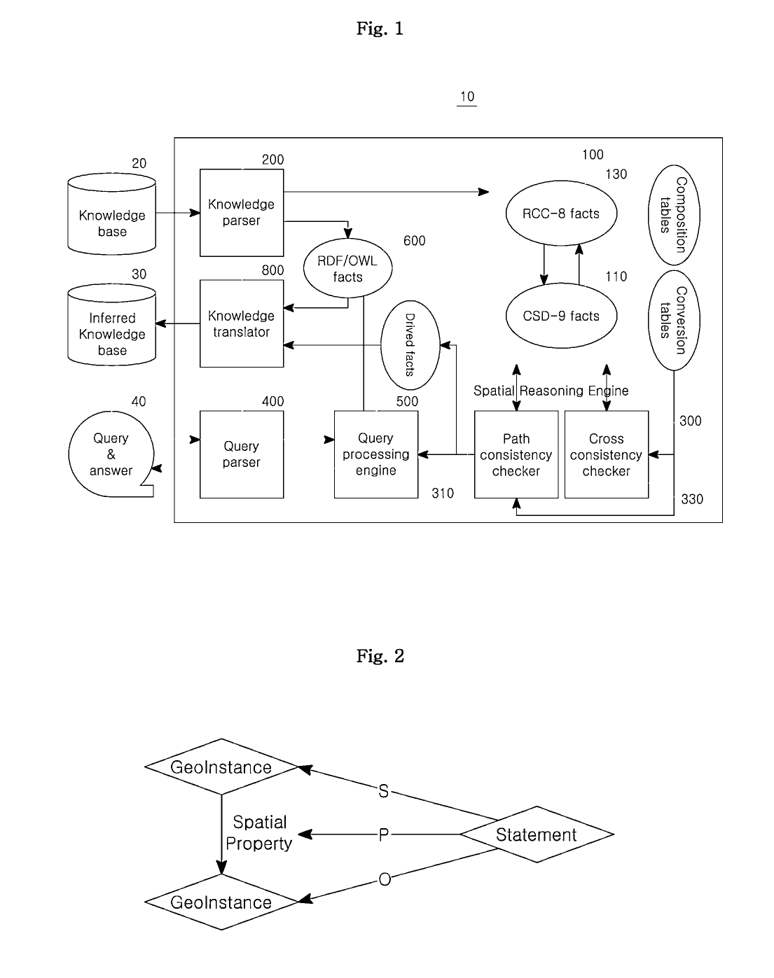

FIG. 1 is a block diagram illustrating a spatial reasoner for reasoning a topological relation and a directional relation between two geo-entities according to an embodiment of the present invention;

As illustrated in FIG. 1, a spatial reasoner 10 according to the present embodiment includes a plurality of spatial knowledge bases 100, a spatial reasoning engine 300, and a query processing engine 500. The spatial reasoner 10 may further include at least one of a knowledge parser 200, a query parser 400, general knowledge bases 600, and a knowledge translator 800.

The plurality of spatial knowledge bases 100 are knowledge bases in which spatial relations are defined, and may include a knowledge base representing a directional relation between geo-entities and a knowledge base representing a topological relation between geo-entities. For example, the knowledge base representing the directional relation between geo-entities may be a cone-shaped directional (CSD)-9 knowledge base 110, and the knowledge base representing the topological relation between geo-entities may be a region connection calculus (RCC)-8 knowledge base 130.

The query processing engine 500 answers to a spatial query using new spatial relations inferred from the spatial reasoning engine 300. When a spatial query including at least one spatial relation is given from an external query and answer 40, the query parser 400 delivers the spatial query to the query processing engine 500. The spatial query may use a semantic Web standard, for example, may have an SPARQL language format.

The query processing engine 500 requests a spatial relation from the spatial reasoning engine 300, finds an answer to a query, and returns a result thereof to a user.

The knowledge parser 200 divides and delivers regional knowledge included in an external knowledge base 20 to the spatial knowledge base 100 in which spatial relations are defined or the general knowledge base 600 in which general relations are defined. The general knowledge base 600 may be an RDF/OWL knowledge base.

New spatial relations inferred from the spatial reasoning engine 300 or the general relations are translated through the knowledge translator 800 and may be stored in an external inferred knowledge base 30.

In order to design the spatial reasoner, first, it is necessary to determine how to represent spatial knowledge necessary for reasoning, that is, spatial knowledge representation. In the present invention, it is assumed that all spatial knowledge bases used for reasoning are represented as triple statements of an (s p o) format according to a semantic Web standard ontology language RDF/OWL, and each location mentioned in the knowledge base is defined as an element included in a GeoInstance class.

Also, as illustrated in FIG. 2, each statement or fact forming the spatial knowledge base may represent a direction, a boundary, an inclusion relation, and the like between two geo-entities using SpatialProperties defined in CSD-9 and RCC-8. For example, a directional relation between spaces “the US state Oregon is located to the north of California” may be represented as (Oregon N California).

In the present invention, based on a cone-shaped directional (CSD)-9 theory, it is assumed that, when a point is determined as a center in a directional relation between any two points on a 2D space, a direction of the other point may be represented as any of a total of 9 directions such as east (E), west (W), south (S), north (N), northeast (NE), northwest (NW), southeast (SE), southwest (SW), and identical as illustrated in FIG. 3.

Also, in the present invention, based on a region connection calculus (RCC)-8 theory, it is assumed that a topological relation between any two regions on a 2D space may be represented as any of a total of 8 relations such as disconnect (DC), externally connected (EC), partially overlapping (PO), equal (EQ), tangential proper part (TPP), tangential proper part inverse (TPPi), non-tangential proper part (NTPP), and non-tangential proper part inverse (NTPPi) as illustrated in FIG. 4.

Therefore, it may be considered that a directional relation between two spaces is described from a perspective of a point in CSD-9 spatial knowledge, but a boundary and an inclusion relation between two spaces are described from a perspective of a region in RCC-8 spatial knowledge. Due to various aspects in which many real world spaces or locations need to be interpreted as a point in some cases or a region in other cases, the CSD-9 spatial knowledge and the RCC-8 spatial knowledge may be mutually complementarily used to represent and reason various relations between real world spaces.

The spatial reasoning engine 300 infers new spatial relations through cross consistency check of the spatial knowledge bases 100. In the related art, consistency check was performed on only each spatial knowledge base. However, in the present invention, not only a consistency check of each spatial knowledge base but also a cross consistency check is performed to obtain a reasoning result more completely.

For this purpose, the spatial reasoning engine 300 includes a path consistency checker 310 configured to check path consistency of a spatial relation set of each spatial knowledge base and a cross consistency checker 330 configured to check cross consistency between the spatial relation sets. The spatial reasoning engine 300 may perform a consistency check using a CSD-9 composition table, an RCC-8 composition table, and a conversion table of CSD-9 and RCC-8.

Hereinafter, a spatial reasoning model of the spatial reasoning engine 300 will be described in detail.

CSD-9 spatial reasoning rules applied to the spatial knowledge base represented as 9 directional relations may be summarized as a composition table in the following Table 1.

TABLE 1

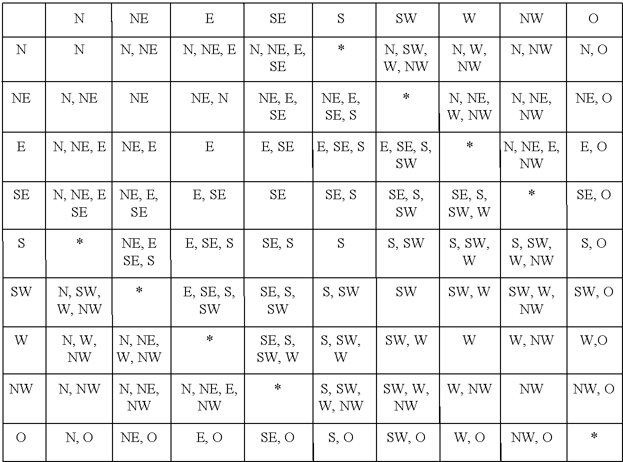

That is, Table 1 suggests that, when a fact of a horizontal row and a fact of a vertical column are true at the same time, it is possible to combine new facts listed in a section in which the corresponding row and column intersect each other. For example, as shown in a shaded section in Table 1, when a location A is located to the north of a location B (N (A, B)), and B is located to the northeast of a location C (NE (B, C)), it is possible to reason new facts that A may be located to the north or northeast of C ([N, NE] (A, C)). Also, when the directional relation between two spaces is clearly defined as one such as N (A, B) and NE (B, C), these facts are called defined relations. On the other hand, when the directional relation between two spaces is difficult to be clearly defined as one such as [N, NE] (A, C), these are called disjunctive relations.

As a similar method, RCC spatial reasoning rules may be summarized as a composition table in the following Table 2.

TABLE 2

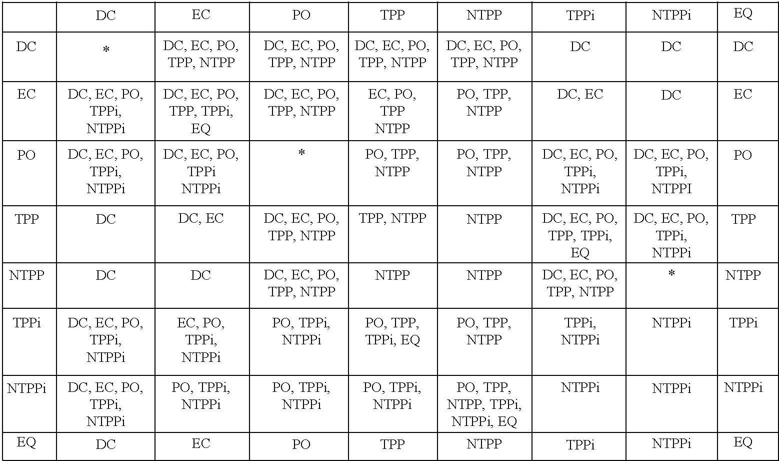

For example, as shown in a shaded section in Table 2, when A is tangent to a boundary of B (EC (A, B)), and B completely includes C without a tangent point (NTPPi (B, C)), it is possible to reason a new fact that A and C are separated (DC (A, C)). In this context, a reasoning process of inferring new facts from existing spatial knowledge bases according to the composition tables of Table 1 and Table 2 is also called composition.

Originally, CSD-9 and RCC-8 are independent theories of dealing with spatial knowledge representation and reasoning methods in different domains. However, in many real world spaces and locations, a directional relation such as CSD-9 and an inclusion relation such as RCC-8 need to be represented and reasoned together. In this case, a spatial reasoning algorithm for integrally reasoning needs to know what new facts can be derived from facts representing a directional relation of CSD-9 in a perspective of an inclusion relation of RCC-8, or which reasoning is possible in a direction opposite thereto. In the present invention, by analyzing various cases of the spatial knowledge base, conversion rules between relations of CSD-9 and RCC-8 are defined as the following Table 3.

TABLE 3

| CSD-9 | RCC-8 |
|---|---|
| O | EQ, PO, TPPi, NTPPi, TPP, NTPP |
| N, NE, E, SE, S, SW, W, NW | DC, EC, PO |

In Table 3, a fact representing a relation O (identical) of CSD-9 suggests a fact that any of relations of {EQ, PO, TPPi, NTPPi, TPP, NTPP} of RCC-8 can be satisfied. A fact representing relations of {N, NE, E, SE, S, SW, W, NW} of CSD-9 suggests a fact that any of relations of {DC, EC, PO} of RCC-8 can be satisfied. Also, in a direction opposite thereto, relations such as {EQ, PO, TPPi, NTPPi, TPP, NTPP} of RCC-8 suggest the relation O of CSD-9, and relations such as {DC, EC, PO} of RCC-8 may satisfy relations such as {N, NE, E, SE, S, SW, W, NW} of CSD-9.

Therefore, when disjunctive relations or a defined relation corresponding to each case is found in the knowledge base, it is possible to convert the relation into a new defined relation or disjunctive relations suggested therefrom. For example, because the US state California completely includes LA (California NTPPi LA), it is not possible to describe California as being located in any of 8 directions of LA. Therefore, it may be interpreted that the State of California has a relation identical to LA (California O LA). When two regions satisfies a partially overlapping PO relation, the two regions may be interpreted as having any relation of an identical (O) relation or the remaining 8 directions according to locations of centers of two regions.

Hereinafter, based on the spatial reasoning rules summarized in Table 1, Table 2, and Table 3, the spatial reasoning algorithm will be proposed.

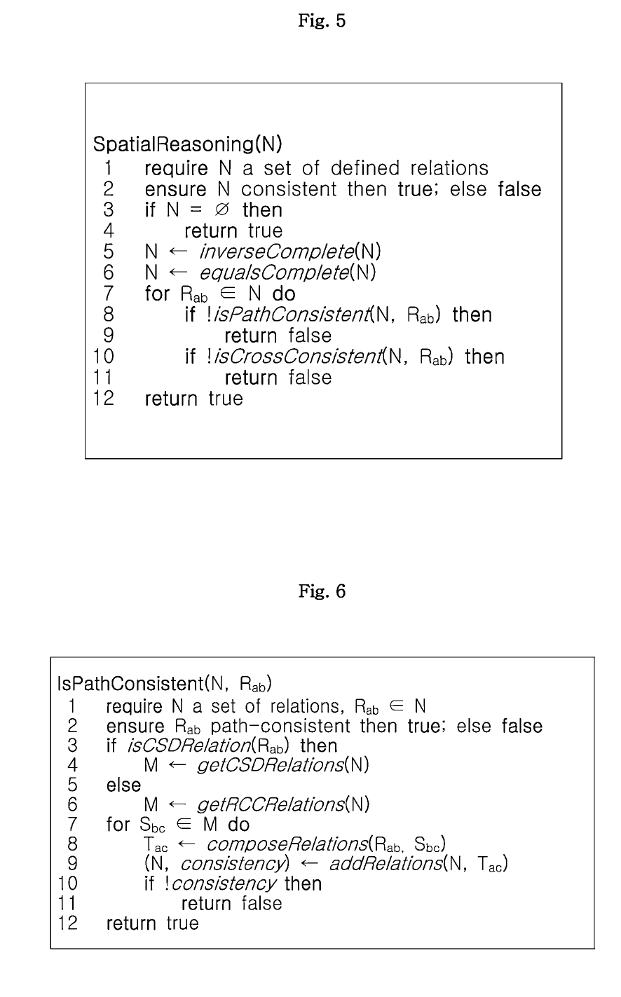

FIG. 5 shows a pseudo code summarizing an entire process of the spatial reasoning algorithm.

As illustrated in FIG. 5, the spatial reasoning algorithm includes detailed operations of checking consistency of a set N of spatial relations of CSD-9 and RCC-8 included in the knowledge base. When the set N is an empty set or all spatial relations constituting N satisfy path consistency, the algorithm is successfully completed (Lines 1 to 4).

In operations of inverseComplete (N) and equalsComplete (N), an inverse relation and an equal relation of all spatial relations included in N are generated. For example, with respect to a spatial relation of N (A, B), an inverse relation S (B, A) and equal relations O (A, A) and O (B, B) are generated (Lines 5 to 6).

Based on a spatial relation Rab, a check of IsPathConsistent (N, Rab) and a check of IsCrossConsistent (N, Rab) are repeatedly performed on each of all currently generated spatial relations. In this case, when inconsistency of the knowledge base is found, reasoning stops (Lines 7 to 11).

IsPathConsistent (N, Rab) performs a path consistency check on relation sets themselves of CSD-9 and RCC-8 using Table 1 and Table 2. On the other hand, IsCrossConsistent (N, Rab) performs a cross consistency check between relations of CSD-9 and RCC-8 using Table 3. FIG. 6 shows an algorithm of IsPathConsistent (N, Rab) that performs a path consistency check on relation sets themselves of CSD-9 and RCC-8 based on the relation Rab. When a result is obtained that Rab is knowledge of a CSD-9 perspective through an operation of isCSDRelation (Rab), all knowledge of the CSD-9 perspective among a set N is stored in a set M, and otherwise, all knowledge of an RCC-8 perspective among the set N is stored in the set M (Lines 3 to 6).

Then, operations of composeRelations (Rab, Sbc) and addRelations (N, Tac) are repeatedly performed on knowledge (Sbc) on which composition reasoning with Rab is possible from M. In the operation of composeRelations (Rab, Sbc), a new spatial relation (Tac) is generated through a composition reasoning process of Rab and Sbc.

Then, in the operation of addRelations (N, Tac), a new spatial relation is stored in the set N, and at the same time, a check is performed to determine whether the new spatial relation has consistency with existing relations (Lines 7 to 12). According to the path consistency check, new spatial relations that can be composed from existing spatial relations are generated.

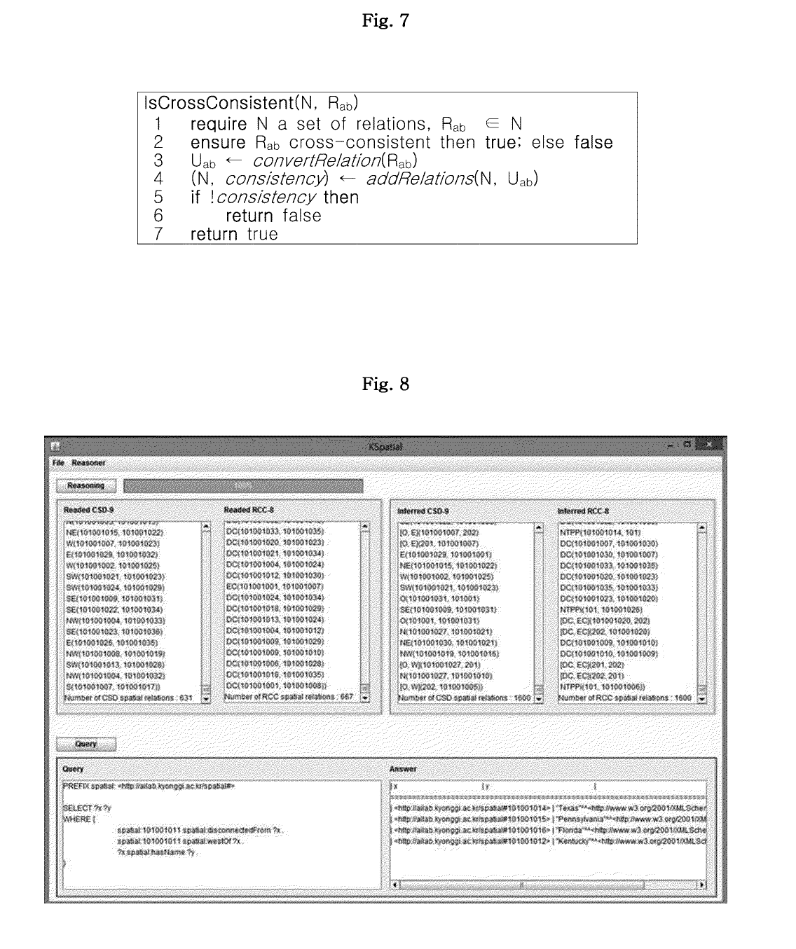

FIG. 7 shows an algorithm of IsCrossConsistent (N, Rab) that performs a cross consistency check on relations between CSD-9 and RCC-8 based on a relation Rab. In an operation of convertRelation (Rab), a new cross spatial relation for Rab is derived (Line 3). For example, a cross spatial relation [DC, EC, PO] (A, B) is generated from a spatial relation N (A, B).

Then, as described above, the operation of addRelation (N, Uab) is performed (Lines 4 to 7). According to this cross consistency check, a spatial relation of a different perspective is also generated.

FIG. 8 shows an execution screen of a spatial reasoner according to the present embodiment.

As shown in FIG. 8, the top of the screen shows a spatial reasoning function and the bottom thereof shows a query processing function. The top left of the screen shows a regional knowledge base read from a file and the top right shows a knowledge base that is newly inferred through reasoning. On the other hand, the bottom left of the screen shows a spatial query and the bottom right thereof shows an answer to the query.

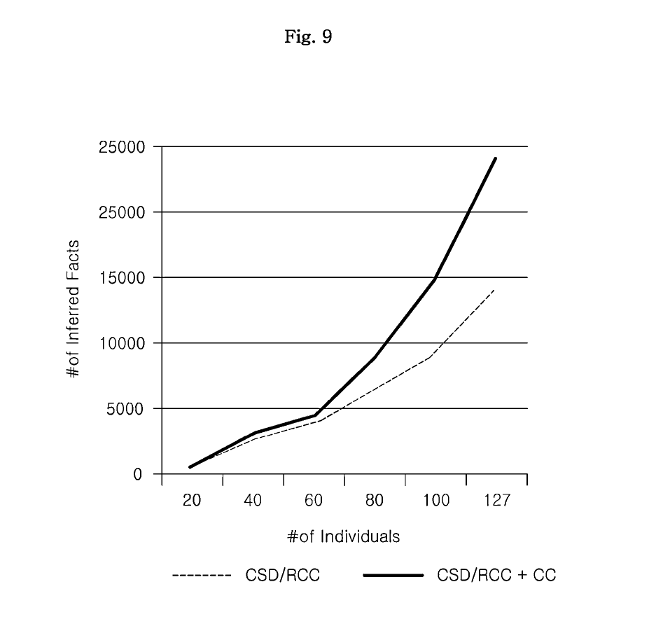

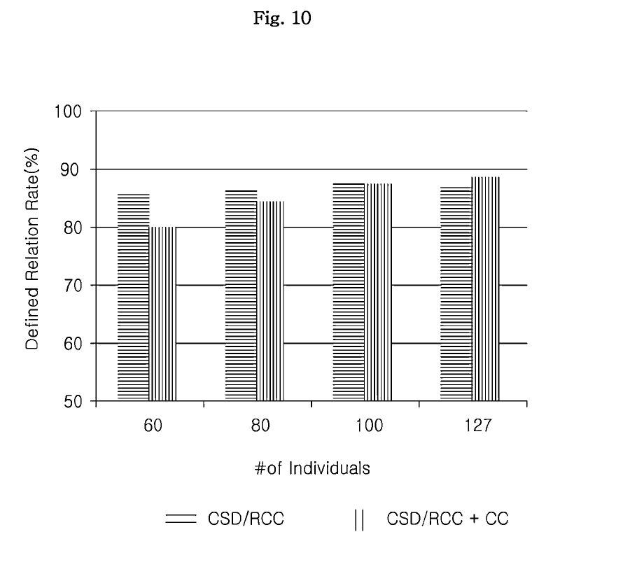

Hereinafter, a result of an experiment in which performance of the spatial reasoning algorithm is analyzed using the spatial reasoner 10 and the spatial knowledge bases 100 of the present invention will be described with reference to FIGS. 9 and 10. In order to perform an experiment of analyzing performances of the spatial reasoning algorithm and the spatial reasoner proposed in the present invention, a spatial knowledge base was built using an ontology editor Protégé. For example, the spatial reasoner and the spatial knowledge base may be implemented by a Java programming language.

The spatial knowledge base including geographic information such as representative states, counties, cities, and lakes of the USA, and the like includes 9 classes, 127 individuals, and 1900 spatial relations (facts) in total. The spatial knowledge base is defined as an RDF/OWL format, and each individual includes an ID, a class type, a name, description, and a CSD-9/RCC-8 spatial relation with other individuals.

In each experiment, performances of the spatial reasoning algorithm (CSD/RCC) in which only a basic CSD/RCC path consistency check (choros method) was performed in the related art and the algorithm (CSD/RCC+CC) in which a cross consistency check was additionally introduced in the present invention were compared.

In a first experiment, two algorithms were compared in terms of a quantity of new knowledge obtained as a reasoning result. FIG. 9 shows the experiment result. As illustrated in FIG. 9, as a size of the spatial knowledge base that is given as an input of reasoning increases, it can be understood that an amount of new knowledge that is generated by the reasoning algorithm proposed in the present invention is significantly more greatly increased than that of the spatial reasoning algorithm in the related art.

This result means that the proposed algorithm has a more excellent reasoning ability to infer new knowledge than the algorithm in the related art.

In a second experiment, two algorithms were compared in terms of certainty of the reasoned knowledge. FIG. 10 shows the experiment result. As illustrated in FIG. 10, certainty of the reasoning knowledge was measured by a ratio of the number of defined relations with respect to inferred relations.

As illustrated in FIG. 10, it can be understood that the spatial reasoning algorithm of the present invention has a higher level of certainty than the algorithm in the related art. This result means that the algorithm of the present invention has an excellent reasoning ability to infer accurate knowledge although it infers much more knowledge than the algorithm in the related art.

The above-described spatial reasoner 10 and spatial reasoning method of reasoning a topological relation and a directional relation between two geo-entities according to the present invention may be implemented as a form of a program instruction that can be performed through various computer components and may be recorded in computer-readable recording media. The computer-readable recording media may include a program instruction, a data file, a data structure, and/or combinations thereof. The program instruction recorded in the computer-readable recording media may be specially designed and prepared for the invention or may be an available well-known instruction for those skilled in the field of computer software. Examples of the computer-readable recording media include, for example, magnetic media such as a hard disk, a floppy disk, and a magnetic tape, optical media such as a CD-ROM and a DVD, magneto-optical media such as a floptical disk, and a hardware device, such as a ROM, a RAM, and a flash memory, that is specially made to store and perform the program instruction. Examples of the program instruction may include a machine language code generated by a compiler and a high-level language code that can be executed by a computer using an interpreter. Such a hardware device may be configured as at least one software module in order to perform operations of the invention and vice versa.

The present invention provides the efficient spatial reasoning algorithm and the spatial knowledge representation based on CSD-9 and RCC-8. The spatial reasoning algorithm according to the present invention may perform a path consistency check on each spatial knowledge base of CSD-9 and RCC-8 and perform a cross consistency check, thereby obtaining a reasoning result more completely.

The present invention provides core technology for a qualitative spatial reasoner that may be very effectively used when detailed quantitative information such as location coordinates, areas, shapes, and the like of geo-entities is difficult to obtain or in the field of various spatial information application systems having high complexity of quantitative calculation. Also, the present invention provides an RCC-8 knowledge base representing a topological relation between geo-entities, a CSD-9 knowledge base representing a directional relation thereof, and a function of a cross consistency check between two spatial knowledge bases. Therefore, more efficient and complete spatial reasoning is possible. In addition, it is possible to effectively answer to spatial queries having an SPARQL format based on the spatial reasoning algorithm proposed according to the present invention.

While the present invention has been described with reference to exemplary embodiments, it will be understood by those skilled in the art that various changes and modifications may be made without departing from the spirit and scope of the present invention as defined by the appended claims.

According to a method of reasoning a topological relation and a directional relation between two geo-entities, a recording medium for performing the method, and the spatial reasoner of the present invention, there are provided an efficient spatial reasoning algorithm, a spatial reasoning model, and spatial knowledge representation based on CSD-9 and RCC-8 theories. The spatial reasoning algorithm of the present invention was designed to obtain a reasoning result more completely by performing a path consistency check on each spatial knowledge base of CSD-9 and RCC-8 and a cross consistency check. Also, the present invention provides an architecture of an efficient spatial reasoner that may effectively answer to spatial queries having an SPARQL format based on the proposed spatial reasoning algorithm. Therefore, the present invention may be used for very diverse spatial information application systems such as a deep query answer system, a large scale geographic information system in the field of construction, public works, administration, military, and safety management, an intelligent learning system focusing on people, geography, and history, intelligent robots and exploration systems, spatio-temporal digital content service fields, and the like.

What is claimed is:

1. A non-transitory computer-readable storage device containing computer program instructions for a computerized automatic spatial reasoning, the non-transitory computer-readable storage device comprising:
a plurality of spatial knowledge base units, each of the spatial knowledge units defining a first spatial relation between geo-entities;
a spatial reasoning engine unit configured to infer a second spatial relation between the geo-entities through a cross consistency check of the plurality of spatial knowledge base units; and
a query processing engine unit configured to answer to a spatial query from a user based on the second spatial relation inferred from the spatial reasoning engine unit.

2. The non-transitory computer-readable storage device according to claim 1,
wherein the spatial reasoning engine unit comprises:
a path consistency checker unit configured to check a path consistency of each of the plurality of spatial knowledge base units; and
a cross consistency checker unit configured to check a cross consistency between the plurality of spatial knowledge base units.

3. The non-transitory computer-readable storage device according to claim 1,
wherein the plurality of spatial knowledge base units comprises:
a first knowledge base unit defining a directional relation between the geo-entities; and
a second knowledge base unit defining a topological relation between the geo-entities.

4. The non-transitory computer-readable storage device according to claim 1,
wherein the plurality of spatial knowledge base units include a cone-shaped directional (CSD)-9 knowledge base unit and a region connection calculus (RCC)-8 knowledge base unit.

5. The non-transitory computer-readable storage device according to claim 4,
wherein the spatial reasoning engine unit performs a consistency check using a relation composition table of CSD-9, a composition table of RCC-8, and a conversion table of CSD-9 and RCC-8.

6. The non-transitory computer-readable storage device according to claim 1, wherein the non-transitory computer-readable storage device further comprises a knowledge parser unit configured to divide and deliver regional knowledge into a spatial knowledge base unit or a general knowledge base unit.

7. The non-transitory computer-readable storage device according to claim 1, wherein the non-transitory computer-readable storage device further comprises a query parser unit, upon receipt of a spatial query including at least one spatial relation, configured to deliver the spatial query to the query processing engine unit.

8. The non-transitory computer-readable storage device according to claim 7, wherein the spatial query is provided in an SPARQL language format.

9. A spatial reasoning method of reasoning a topological relation and a directional relation between two geo-entities, the method comprising:
through a cross consistency check of a plurality of spatial knowledge base units defining a first spatial relation between the geo-entities, inferring a second spatial relation between the geo-entities; and
answering to a spatial query from a user based on the second spatial relation between the geo-entities.

10. A computer-readable recording medium recording a computer program for performing the spatial reasoning method of reasoning a topological relation and a directional relation between two geo-entities, the computer-readable recording medium comprising:
through a cross consistency check of a plurality of spatial knowledge base units defining a first spatial relation between the geo-entities, inferring a second spatial relation between the geo-entities; and
answering to a spatial query from a user based on the second spatial relation between the geo-entities.
